(19) United States
(12) Patent Application Publication
(10) Pub. No.: US 2026/0172357 A1
(43) Pub. Date: Jun. 18, 2026

(54) DAMPENING PATH MONITORING FOR A TRAFFIC STEERING POLICY

(71) Applicant: Arista Networks, Inc., Santa Clara, CA (US)

(72) Inventors: Imtiyaz Mohammad, Bengaluru (IN); Arpit Bansal, Bangalore (IN)

(21) Appl. No.: 18/979,964

(22) Filed: Dec. 13, 2024

(51) Int. Cl. H04L 47/125; H04L 43/10; H04L 45/00

(52) U.S. Cl. CPC H04L 47/125; H04L 43/10; H04L 45/34

(57) ABSTRACT

A technique dampens path monitoring in a network device. Such a technique involves providing a traffic steering policy that specifies a first valid candidate path and a second valid candidate path. Such a technique further involves, in response to the first valid candidate path being active, configuring a path monitoring mechanism to apply routine path monitoring criteria to the first valid candidate path to perform path monitoring on the first valid candidate path at a routine level. Such a technique further involves, in response to the second valid candidate path being inactive, configuring the path monitoring mechanism to apply dampening path monitoring criteria to the second valid candidate path to dampen path monitoring on the second valid candidate path below the routine level. Accordingly, the technique lessens the path monitoring workload in the network device and reduces the risk of encountering overloading situations.

### BACKGROUND

In network systems, network devices commonly use Segment Routing Traffic Engineering (SR-TE) policies to steer packets from headend devices to endpoint devices. Such network devices may further use Seamless Bidirectional Forwarding Detection (SBFD) to validate candidate paths of the SR-TE policies. A “candidate path” refers to a route through a network and is defined by at least one segment list, i.e., a list of next hops that a packet follows from a headend device to an endpoint device. In SR-TE, a candidate path may include multiple segment lists, which allow for load balancing across respective pathways, e.g., using equal cost multi-path (ECMP) routing.

In a conventional network system as described above, a headend device uses SBFD to monitor candidate paths of an SR-TE policy by periodically sending "Hello" packets on the candidate paths to an endpoint device at a predefined rate. If the headend device receives back a proper response to a "Hello" packet within a specified time limit, the headend device considers the candidate path to be valid (or healthy). However, if the headend device does not receive back a proper response within the specified time limit, the headend device considers the candidate path to be down (or unhealthy). Some headend devices are configured to re-evaluate the choice of which candidate path is used as the currently active path when the headend device detects a change in candidate-path health.

### BRIEF DESCRIPTION OF THE DRAWINGS

The foregoing and other objects, features and advantages will be apparent from the following description of particular embodiments of the present disclosure, as illustrated in the accompanying drawings in which like reference characters refer to the same parts throughout the different views. The drawings are not necessarily to scale, emphasis instead being placed upon illustrating the principles of various embodiments of the present disclosure.

FIG. 1 is a block diagram of a network environment in which a network device is configured to dampen path monitoring for inactive paths of a traffic steering policy in accordance with one or more embodiments.

FIG. 2 is a flowchart of a procedure that may be performed in accordance with one or more embodiments.

FIG. 3 is a block diagram of an example traffic steering policy during an un-optimized path monitoring situation in accordance with one or more embodiments.

FIG. 4 is a block diagram of the example traffic steering policy during an optimized path monitoring situation in accordance with one or more embodiments.

FIG. 5 is a block diagram of the example traffic steering policy during another optimized path monitoring situation in accordance with one or more embodiments.

FIG. 6 is a block diagram of certain components of a network device which is capable of dampening path monitoring in accordance with one or more embodiments.

FIG. 7 is a block diagram of electronic equipment which is suitable for forming at least some of the components of FIG. 6 in accordance with one or more embodiments.

### DETAILED DESCRIPTION

### Overview

In a conventional headend device that uses Seamless Bidirectional Forwarding Detection (SBFD) to validate candidate paths of a Segment Routing Traffic Engineering (SR-TE) policy, a central processing unit (CPU) of the headend device processes responses to "Hello" packets, which SBFD periodically sends on candidate paths at a predefined rate. If the CPU determines that a proper response to a "Hello" packet sent on a candidate path is not received back within a specified time limit, the headend device considers that candidate path to be down and may re-evaluate the choice of which candidate path is used as the currently active path.

Unfortunately, such "Hello" packet processing by the CPU consumes resources (e.g., CPU cycles, memory, etc.). Moreover, resource consumption increases with increased number of SR-TE policies, candidate paths per policy, and segment lists per candidate path. In certain scaling situations, the CPU may have difficulty keeping up with such processing. If such situations remain unaddressed, errors or inefficiencies may arise, such as "Hello" packet timing requirements not being met, false indications being issued that paths are down, and delayed or lost traffic due to such false indications. Accordingly, there is a need to reduce the path monitoring workload in network devices.

The above need is addressed at least in part by an improved technique that includes dampening path monitoring for inactive candidate paths of a traffic steering policy. Dampening of path monitoring may involve slowing the pace at which a network device’s path monitoring mechanism sends and receives test packets (e.g., SBFD "Hello" packets) or disabling path monitoring for the inactive candidate paths altogether. Such dampening reduces loading (resources consumed), thus enabling the network device to reliably process test packets for the candidate path that is currently active (“in use”) and to effectively perform other operations handled by the network device. Accordingly, such dampening avoids errors and inefficiencies, such as test packet timing requirements not being met, false indications that paths are down, and/or delayed or lost traffic due to such false indications.

As will be explained in further detail below, SR-TE is a suitable protocol for the traffic steering policy. Additionally, SBFD is a suitable path monitoring mechanism for confirming validation of candidate paths of the traffic steering policy.

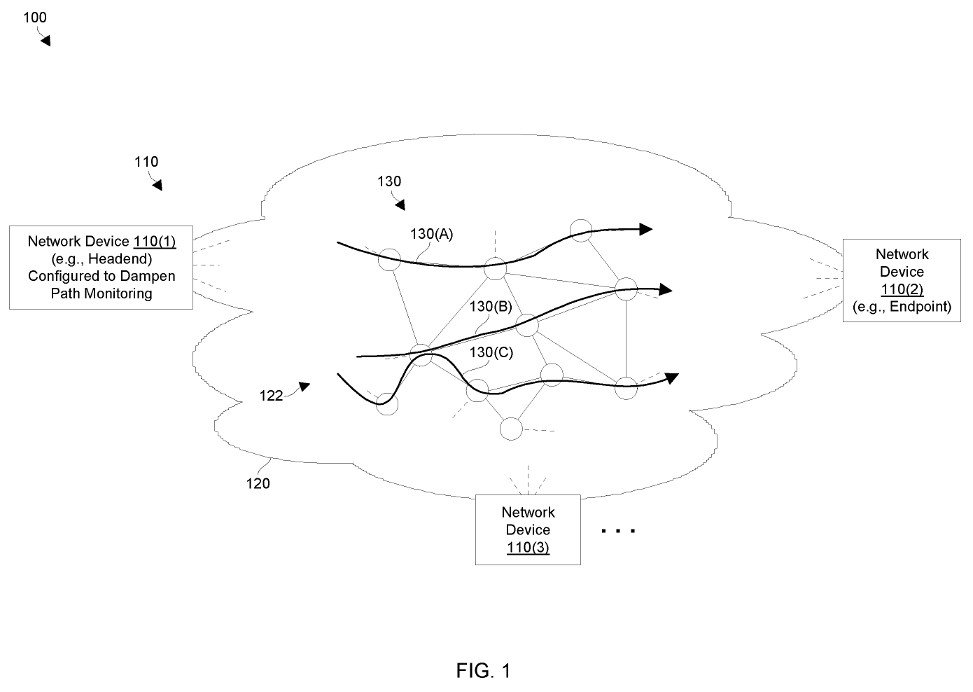

FIG. 1 shows a network environment 100 in which a network device dampens path monitoring for inactive paths of a traffic steering policy in accordance with one or more embodiments. The network environment 100 includes network devices 110(1), 110(2), 110(3), … (collectively, network devices 110), and a communications fabric 120 that interconnects the network devices 110.

The network devices 110 are constructed and arranged to communicate with one another through the communications fabric 120. Along these lines, the network devices 110 may employ one or more routing protocols such as those which use traffic steering policies to convey (e.g., forward) packets through traffic engineered paths. The network devices 110 may further employ path monitoring mechanisms such as those which send/receive test packets to ascertain the health of the traffic engineered paths.

It should be understood that a “packet” refers to a unit of data that may be conveyed over a network. Accordingly, the term packet is meant to cover datagrams, frames, cells, and the like, including other types of communications messages and/or signals.

As will be explained in further detail shortly, the network device 110(1) is configured to dampen path monitoring for inactive paths of one or more traffic steering policies. Along these lines, a path monitoring mechanism of the network device 110(1) sends test packets on an active path of a traffic steering policy at a normal (or routine) rate (e.g., at standard time intervals), but dampens the sending of test packets on inactive paths of the traffic steering policy to reduce resource loading in the network device 110(1). Additionally, if the network device 110(1) later chooses a new path of the traffic steering policy to be the active path, the network device 110(1) sends test packets on the new active path at the normal rate, but dampens the sending of test packets on the remaining inactive paths.

It should be understood that the network device 110(1) may operate in this manner for other traffic steering policies as well (e.g., for multiple traffic steering policies managed by the network device 110(1)). Additionally, it should be understood that the other network devices 110 of the network environment 100 may be similarly configured to dampen path monitoring to reduce resource loading in those network devices 110.

The communications fabric 120 is constructed and arranged to convey communications among the network devices 110. Along these lines and as illustrated by the detail identified by reference numeral 122, the communications fabric 120 may include various networking components, cabling, etc. such as routers, switches, bridges, gateways, wireless transceivers, other node devices, copper-based cabling, fiber optic cabling, combinations thereof, and so on. Moreover, the communications fabric 120 may itself include other network devices 110. Such a communications medium enables the network devices 110 to richly and reliably convey communications signals (e.g., packets) through communications links of the communications fabric 120. The communications fabric 120 is illustrated as a cloud to indicate that the communications fabric 120 is capable of having a variety of different topologies including backbone, hub-and-spoke, loop, irregular, combinations thereof, and so on.

During operation, the network devices 110 are able to convey messages to other network devices 110 through the communications fabric 120. Along these lines, such communications may involve the use of traffic steering via SR-TE policies and path monitoring using SBFD.

For example, the network device 110(1) may operate as a headend which employs an SR-TE policy to steer packets to the network device 110(2) as the endpoint. In this example, the SR-TE policy includes candidate paths 130(A), 130(B), 130(C) (collectively, candidate paths 130). By way of example, the candidate path 130(A) is currently considered valid and active (currently used to carry traffic), and the candidate paths 130(B) and 130(C) are currently considered valid but inactive (not currently used to carry traffic).

Also, by way of example, the network device 110(1) may confirm that the candidate path 130(A) is currently healthy using SBFD. To this end, the network device 110(1) may establish an SBFD session for a segment list representing the candidate path 130(A) (a candidate path is defined by at least one segment list). During the SBFD session, the network device 110(1) periodically sends, as test packets, BFD (Bidirectional Forwarding Detection) "Hello" packets on the pathway defined by the segment list and processes responses to the BFD "Hello" packets. If the responses are received within a specified time limit, the network device 110(1) continues to consider the candidate path 130(A) to be valid and maintains selection of the candidate path 130(A) as the active path.

However, if a response to a particular "Hello" packet is not received within the specified time limit, the SBFD session that sent the "Hello" packet may transition from an "Up" state to a "Down" state. In response, the network device 110(1) may re-evaluate path selection and choose a different candidate path as the active path. Along these lines, the network device 110(1) may consider the candidate path 130(A) to no longer be healthy and in accordance with the SR-TE policy select a different valid candidate path 130 as the active path. For example, with the valid candidate paths 130(B) and 130(C) to choose from, the network device 110(1) may choose the valid candidate path 130(B) as the active path in place of the candidate path 130(A). One should appreciate that selection of the active path may be based on additional criteria besides the path being valid, such as numbers of hops, delays, and other criteria.

The valid candidate path 130(B) may then remain the active path indefinitely or may be replaced by another valid candidate path 130 at some point. Along these lines, the candidate path 130(A) may return to being the active path (e.g., if the candidate path 130(A) becomes healthy again). Alternatively or later on, the candidate path 130(C) may become the active candidate path (e.g., in response to the both candidate paths 130(A) and 130(B) being unhealthy), and so on.

It should be understood that, in the example above, the candidate path 130(A) of the SR-TE policy was described above as being defined by a segment list. However, as mentioned earlier, it should be understood that a candidate path 130 of the SR-TE policy may be defined by multiple segment lists and, for such situations, the network device 110(1) establishes multiple SBFD sessions (e.g., one SBFD session per segment list).

It should be further understood that the SR-TE policy employed by the network device 110(1) includes three valid candidate paths 130 by way of example only, and that the SR-TE policy may include any number of candidate paths 130. Along these lines, it should be appreciated that an SR-TE policy represents candidate paths via segment lists, and that a segment list which has a resolvable first segment is referred to as a valid segment list. Additionally, a candidate path represented by at least one valid segment list is referred to as a valid candidate path.

It should be further understood that an SR-TE policy may have more than one valid candidate path. However, the SR-TE policy considers (or selects) only one valid candidate path to be active (chosen to convey traffic) at any point in time. The SR-TE policy considers the remaining valid candidate paths to be inactive, e.g., the remaining valid candidate paths may be kept as backups in a control plane of the network device.

At this point, it should be understood that if the network device 110(1) were to detect failure of the candidate path 130(A), the network device 110(1) may re-apply the SR-TE policy to select the valid candidate path 130(B) or the valid candidate path 130(C) as the new active candidate path. To detect path failures, the network device 110(1) employs SBFD.

Along these lines, the network device 110(1) uses SBFD to send test packets in a normal manner to monitor the health of the particular candidate path 130 of the SR-TE policy which is currently valid and active, e.g., initially the candidate path 130(A). However, to reduce loading, the network device 110(1) dampens SBFD for candidate paths 130 of the SR-TE policy that are currently valid but inactive, e.g., initially the candidate paths 130(B) and 130(C).

### Dampening Path Monitoring on Inactive Paths

In some embodiments, the network device 110(1) dampens path monitoring on the initially valid but inactive candidate paths 130(B) and 130(C) of the SR-TE policy by slowing the pace at which SBFD sends test packets on the valid but inactive candidate paths 130(B) and 130(C). Along these lines, the network device 110(1) configures SBFD with routine path monitoring criteria to periodically send test packets on the valid and active candidate path 130(A) at a routine rate (e.g., at standard or default time intervals). However, the network device 110(1) configures SBFD with dampening path monitoring criteria to periodically send test packets on the valid but inactive candidate paths 130(B) and 130(C) at a dampening rate which is slower than the routine rate. Accordingly, the network device 110(1) sends test packets less frequently on the valid but inactive candidate paths 130(B) and 130(C). As a result, the network device 110(1) consumes fewer resources to send and process test packets and is therefore less loaded.

In this approach, the routine path monitoring criteria may include, among other things, the routine rate that SBFD uses to periodically send test packets, and a routine time limit for SBFD to receive back responses to the test packets (e.g., a multiple of the standard or default time interval). Similarly, the dampening path monitoring criteria may include the dampening rate that SBFD uses to periodically send test packets, and a dampening time limit for SBFD to receive back responses to the test packets.

In one or more embodiments, the dampening rate is at least twice as slow as the routine rate. In one example, the routine rate for sending test packets on the valid and active candidate path 130(A) is every 500 milliseconds (a routine time interval), and the dampening rate for sending test packets on the valid but inactive candidate paths 130(B) and 130(C) is every 1.5 seconds (the routine time interval times three). In another example, the routine rate for sending test packets on the valid and active candidate path 130(A) is every 300 milliseconds, and the dampening rate for sending test packets on the valid but inactive candidate paths 130(B) and 130(C) is every 900 milliseconds. Other rates/time intervals are suitable for use as well as long as the dampening rate is slower than the routine rate.

In other embodiments, the network device 110(1) dampens path monitoring on the initially valid but inactive candidate paths 130(B) and 130(C) of the SR-TE policy by disabling (inhibiting) SBFD from sending test packets on inactive paths of the SR-TE policy altogether. Along these lines, the network device 110(1) configures SBFD with routine path monitoring criteria to periodically send test packets on the valid and active candidate path 130(A) at the routine rate. However, the network device 110(1) disables SBFD for the remaining valid but inactive candidate paths 130(B) and 130(C).

Disabling SBFD from sending test packets on inactive paths is well suited for scaling situations in which the network device 110(1) would otherwise continue to be heavily loaded even if SBFD were configured to send test packets on the remaining valid but inactive candidate paths 130 at the slower rate. With SBFD prevented from sending test packets on inactive paths of the SR-TE policy, the network device 110(1) consumes fewer resources and is less loaded.

In certain embodiments, the network device 110(1) is configurable to enable selection of either dampening SBFD by slowing (or reducing) the pace at which SBFD sends test packets on the valid but inactive candidate paths 130 or by disabling (or inhibiting) SBFD on valid but inactive candidate paths 130 altogether. Such selection may be performed in an automated manner (e.g., based on one or more sensed conditions/events such as current traffic flow, loading, etc.) and/or manually (e.g., set by an operator/administrator). Moreover, the network device 110(1) may be configured to dampen path monitoring by slowing the pace at which SBFD sends test packets on the valid but inactive candidate paths 130 during one period of time and dampen path monitoring by disabling SBFD on valid but inactive candidate paths 130 altogether during another period of time. Such embodiments provide a great amount of flexibility in dampening path monitoring of inactive candidate paths of an SR-TE policy.

It should be understood that the network device 110(1) may use other SR-TE policies for further traffic steering within the network environment 100. Moreover, when the network device 110(1) uses multiple SR-TE policies, the network device 110(1) enables control over which SR-TE policies are provided with path monitoring dampening of valid but inactive candidate paths 130 and which are not.

It should be further understood that one or more of the other network devices 110(2), 110(3), … may also be configured to dampen path monitoring of valid but inactive candidate paths 130 of SR-TE policies. That is, the features described above in connection with the network device 110(1) may be provided for any other network device 110 of the network environment 100 (e.g., for the network device 110(2), for the network device 110(3), combinations thereof, and so on).

It should be understood that the network device 110(1) is described above as employing SR-TE as a traffic steering policy by way of example only. It should be understood that other traffic steering policies are also suitable for use, such as multiprotocol label switching (MPLS) Traffic Engineering (MPLS-TE), policy-based routing (PBR), quality of service (QoS) based routing, among others. Thus, embodiments are not limited to those which use SR-TE traffic steering policy.

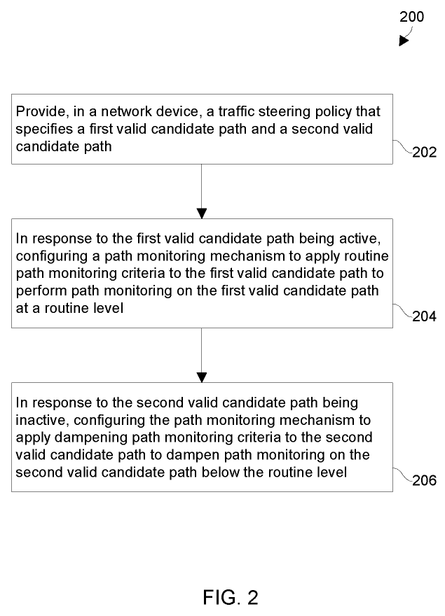

It should be further understood that the network device 110(1) was described above as employing the use of SBFD as the path monitoring mechanism by way of example only. It should be understood that other path monitoring mechanisms are also suitable for use, such as BFD, Internet Control Packet Protocol (ICMP) (ping), and various heartbeat mechanisms, among others. Thus, embodiments are not limited to those which use SBFD. Further details will now be provided with reference to FIG. 2.

FIG. 2 is a flowchart of a procedure 200 for dampening path monitoring in a network device in accordance with one or more embodiments. The procedure 200 may be performed, for example, by the network device 110(1) of FIG. 1, or by any other network device. Such a procedure dampens path monitoring on valid but inactive candidate paths of a traffic steering policy, thus enabling a reduction in resource consumption and less loading.

At 202, the network device provides a traffic steering policy that specifies a first valid candidate path and a second valid candidate path. It should be understood that the traffic steering policy may include greater than two valid candidate paths (e.g., three, four, ten, hundreds, etc.). A suitable traffic steering policy is an SR-TE policy in which sets of valid segment lists represent the valid candidate paths.

At 204, the network device, in response to the first valid candidate path being active, configures a path monitoring mechanism to apply routine path monitoring criteria to the first valid candidate path to perform path monitoring on the first valid candidate path at a routine level. Along these lines, the routine path monitoring criteria may direct the path monitoring mechanism to send test packets on the first valid candidate path at a routine rate. For example, a suitable path monitoring mechanism is SBFD, and the routine path monitoring criteria may direct a set of SBFD sessions to send "Hello" packets on respective pathways at a standard (or normal) rate. Such pathways are defined by respective segment lists, which represent different variants of the first valid candidate path.

At 206, in response to the second valid candidate path being inactive, the network device configures the path monitoring mechanism to apply dampening path monitoring criteria to the second valid candidate path to dampen path monitoring on the second valid candidate path below the routine level. Along these lines, the dampening path monitoring criteria may direct the path monitoring mechanism to send test packets on the second valid candidate path at a dampening rate that is slower than the routine rate or may disable the path monitoring mechanism from sending test packets on the second valid candidate path altogether.

For example, the dampening path monitoring criteria may direct a set of SBFD sessions to send "Hello" packets on a set of pathways defined by respective segment lists representing the second valid candidate path less frequently (e.g., at slower time intervals). Alternatively, the dampening path monitoring criteria may disable the set of SBFD sessions from sending "Hello" packets altogether. It should be understood that, here, the term “set” means one or more.

Accordingly, the path monitoring mechanism consumes fewer resources in the network device than would otherwise be consumed if the path monitoring mechanism were instead configured to apply the routine path monitoring criteria to both the first valid candidate path and the second valid candidate path. As a result, there is less risk of encountering errors and inefficiencies due to overloading, such as test packet timing requirements not being met, false indications that paths are down, and/or delayed or lost traffic due to such false indications.

It should be understood that the network device may initially begin operation in a heavily loaded situation (e.g., when there are many other traffic steering policies handled by the same network device, when the traffic steering policies have many valid candidate paths, when the valid candidate paths are represented by many segment lists, etc.). In such situations, the procedure 200 may be performed immediately.

Also, the network device may initially begin operation in an un-optimized situation in which the path monitoring mechanism applies the same routine path monitoring criteria to all valid candidate paths of the traffic steering policy regardless of whether active or inactive. Such a situation may exist when the network device is first put into service and/or while the network device oversees relatively few candidate paths and is lightly loaded.

At some point, the network device may encounter heavier loading, thus warranting use of the procedure 200. That is, after the network device operates for a period of time in the un-optimized situation with regard to path monitoring, the network device may transition to dampening path monitoring on valid but inactive candidate paths to avoid causing errors and inefficiencies, such as test packet timing requirements not being met, false indications that paths are down, and delayed or lost traffic due to such false indications, and so on.

### Examples

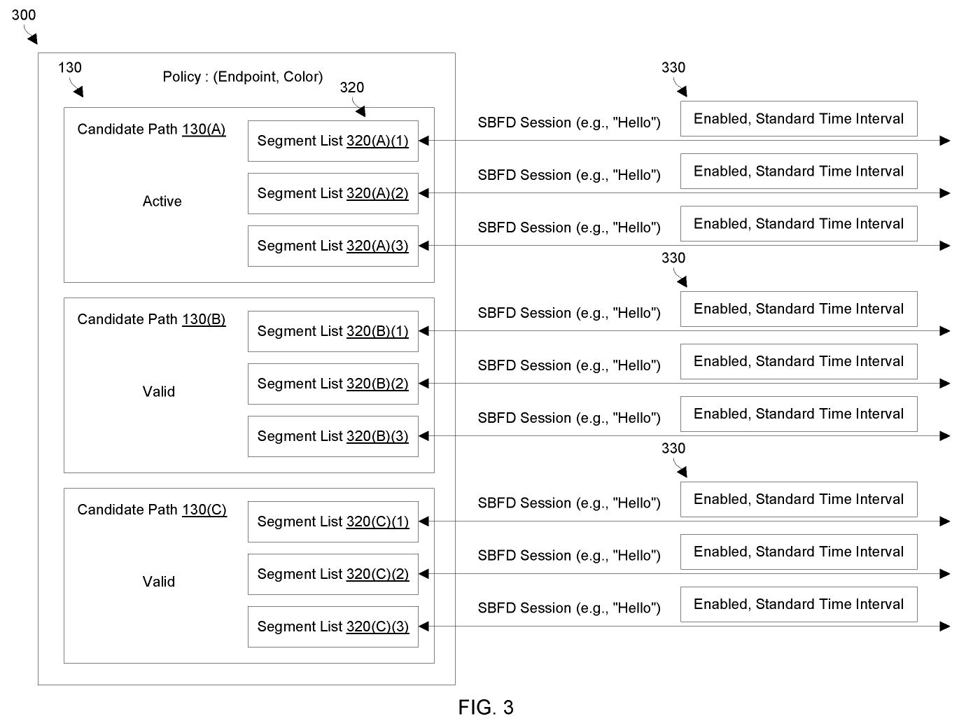

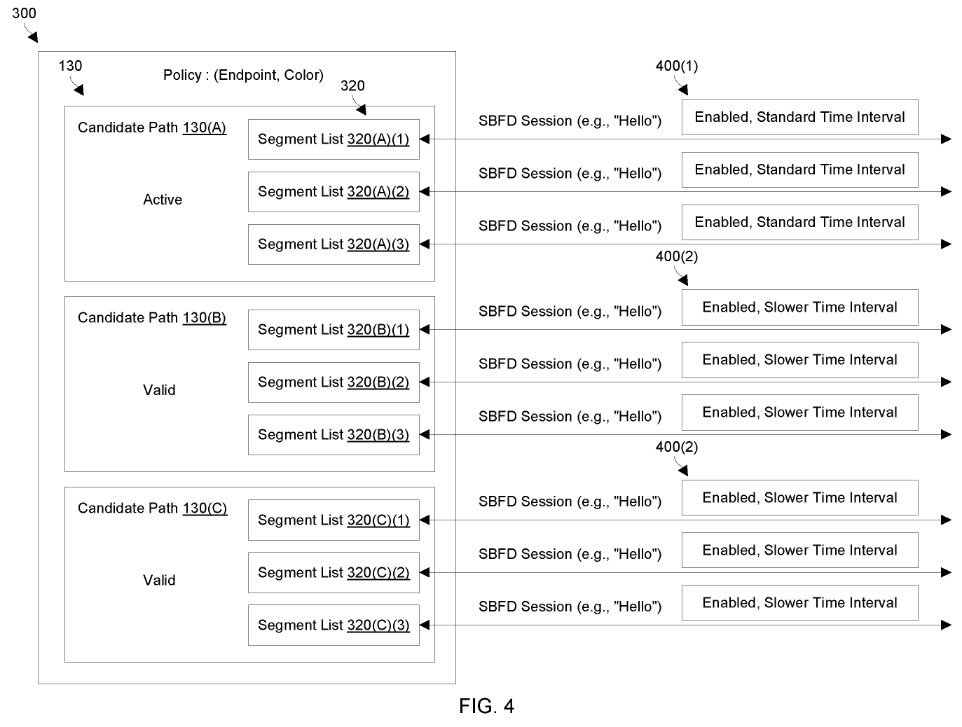

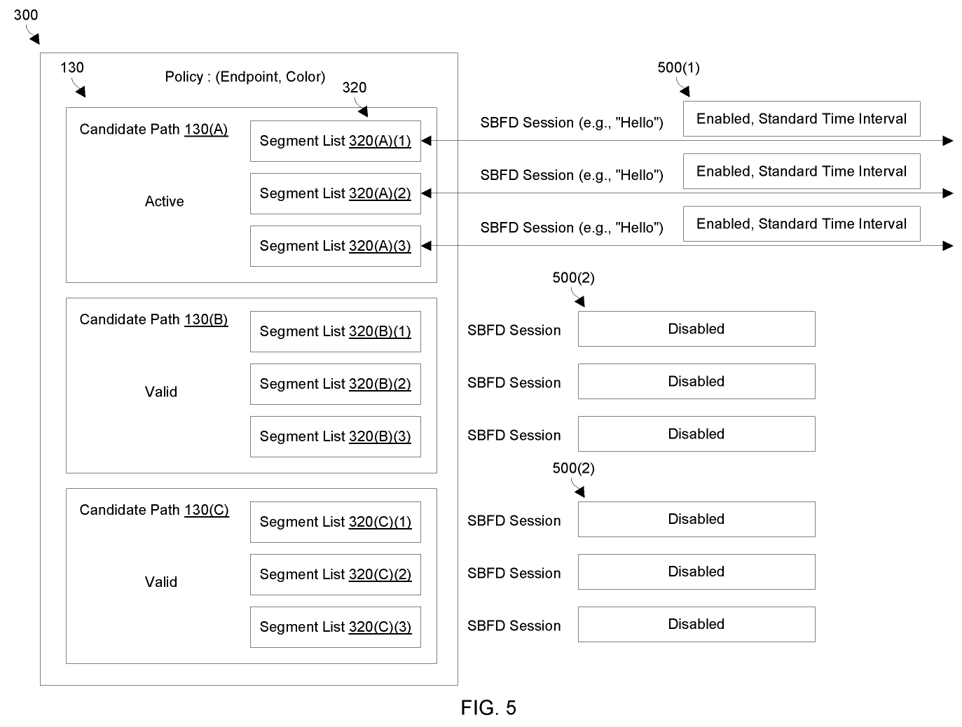

FIGS. 3 through 5 show an example traffic steering policy300 under different path monitoring situations in accordance with one or more embodiments. The traffic steering policy 300 may be realized, for example, by executable code running within a network device 110, such as software or firmware (e.g., see the network device 110(1) in FIG. 1). FIG. 3 shows the example traffic steering policy during an un-optimized path monitoring situation. FIG. 4 shows the example traffic steering policy during an optimized path monitoring situation. FIG. 5 shows the example traffic steering policy during another optimized path monitoring situation.

The traffic steering policy is, by way of example, an SR-TE policy 300 which specifies an endpoint and a color. The endpoint identifies another network device 110. The “color” identifies the SR-TE policy 300 among other SR-TE policies that share the same source and destination (e.g., the network device 110(1) may be the source and the network device 110(2) may be the destination as shown in FIG. 1).

The example SR-TE policy 300 has multiple candidate paths 130 (also see FIG. 1) which are represented (defined) by segment lists 320. In particular, there are three candidate paths 130(A), 130(B), and 130(C) represented by respective sets of segment lists 320. The candidate path 130(A) is represented by a set of three segment lists 320(A)(1), 320(A)(2), and 320(A)(3). Additionally, the candidate path 130(B) is represented by another set of three segment lists 320(B)(1), 320(B)(2), and 320(B)(3). Furthermore, the candidate path 130(C) is represented by yet another set of three segment lists 320(C)(1), 320(C)(2), and 320(C)(3).

Although the SR-TE policy 300 has three candidate paths 130 in this example, it should be understood that the SR-TE policy 300 may have any number of candidate paths 130 (i.e., one or more candidate paths 130). Likewise, it should be understood that each candidate path 130 is represented by three segment lists 320 by way of example only, but that each candidate path 130 may be represented by any number of segment lists 320 (i.e., one or more segment lists 320).

In this example, the candidate path 130(A) is the currently valid and active candidate path of the SR-TE policy 300. The candidate paths 130(B) and 130(C) are currently valid but inactive candidate paths of the SR-TE policy 300.

In the examples of FIGS. 3 through 5, the SR-TE policy 300 utilizes SBFD for path monitoring. Along these lines, the network device 110 establishes respective SBFD sessions for the segment lists 320 (e.g., a dedicated SBFD session per segment list 320), and configures the established SBFD sessions to operate in accordance with certain path monitoring criteria.

As shown in FIG. 3, the SR-TE policy 300 operates in an un-optimized path monitoring situation. In particular, using standard (or routine) path monitoring criteria 330, the network device 110 configures all of the SBFD sessions to remain enabled and to send test packets (e.g., BFD “Hello” packets) on their respective segments at a same standard (or routine) rate.

Along these lines, the path monitoring criteria 330 include parameters that enable all of the SBFD sessions to send test packets and a standard rate (or at a standard time interval) at which to send the test packets. The path monitoring criteria 330 may include additional parameters as well, such as a specified time limit in which to properly receive back responses to the test packets (e.g., as a multiple of the standard time interval), etc.

During operation, the network device 110 processes responses to the test packets by confirming that the responses are received back within such a specified time limit. If there is a response to a particular test packet that is not received back within the specified time limit, the network device 110 may transition the state of the SBFD session that sent the test packet from an “Up” state to a “Down” state, which may then trigger the SR-TE policy 300 to re-evaluate the choice of active candidate path 130.

Unfortunately, such operation may consume substantial resources (e.g., CPU cycles, memory, etc.) of the network device 110. If the network device 110 is heavily loaded, there could be a greater risk of encountering certain problems such as test packet timing requirements not being met, false indications that paths are down, and delayed or lost traffic due to such false indications.

To address this and in accordance with one or more embodiments, different path monitoring criteria are applied to the candidate paths 130 of the SR-TE policy 300 based on whether the candidate paths 130 are valid and active, or valid but inactive. Such application of different path monitoring criteria may provide a more optimal path monitoring situation in terms of loading.

For example, as shown in FIG. 4, the network device 110 configures the SBFD sessions for the segment lists 320 representing the valid and active candidate path 130(A) with standard path monitoring criteria 400(1), and configures the SBFD sessions for the segment lists 320 representing the valid but inactive candidate paths 130(B) and 130(C) with dampening path monitoring criteria 400(2). The standard path monitoring criteria 400(1) configures the SBFD sessions for the segment lists 320 that represent the valid and active candidate path 130(A) to send test packets at a standard rate. However, the dampening path monitoring criteria 400(2) configures the SBFD sessions for the segment lists 320 that represent the valid but inactive candidate paths 130(B) and 130(C) to send test packets at a dampening rate, which is slower than the standard rate.

Along these lines, the standard path monitoring criteria 400(1) includes (i) parameters that enable the SBFD sessions to send test packets, and (ii) the standard rate (also see the path monitoring criteria 330 in FIG. 3). Furthermore, the dampening path monitoring criteria 400(2) includes (i) parameters that enable the SBFD sessions to send test packets, and (ii) the dampening rate, which directs the SBFD sessions to provide test packets at a slower pace. Accordingly, SBFD consumes fewer resources thus reducing loading in the network device 110.

At this point, it should be appreciated that FIG. 4 shows a more optimized path monitoring situation than that of FIG. 3. That is, in the situation of FIG. 4, the dampening path monitoring criteria 400(2) imposes less loading. Accordingly, there is less risk that the situation of FIG. 4 will create certain errors or inefficiencies, such as test packet timing requirements not being met, false indications that paths are down, and delayed or lost traffic due to such false indications.

As another example and as shown in FIG. 5, the network device 110 configures the SBFD sessions for the segment lists 320 representing the valid and active candidate path 130(A) with standard path monitoring criteria 500(1). The network device 100 further configures the SBFD sessions for the segment lists 320 representing the valid but inactive candidate paths 130(B) and 130(C) with dampening path monitoring criteria 500(2). The standard path monitoring criteria 500(1) configures the SBFD sessions for the segment lists 320 representing the valid and active candidate path 130(A) to send test packets at a standard rate. However, the dampening path monitoring criteria 500(2) configures the SBFD sessions for the segment lists 320 representing the valid but inactive candidate paths 130(B) and 130(C) to not send test packets.

Along these lines, the first path monitoring criteria 500(1) includes (i) parameters that enable the SBFD sessions to send test packets, and (ii) the standard rate (also see the path monitoring criteria 330 in FIG. 3). Furthermore, the dampening path monitoring criteria 500(2) includes parameters that disable the SBFD sessions from sending test packets. As a result, SBFD consumes fewer resources and reduces loading in the network device 110.

At this point, it should be appreciated that FIG. 5 shows a more optimized path monitoring situation than that of FIG. 3. That is, in the situation of FIG. 5, the dampening path monitoring criteria 500(2) imposes less loading. Accordingly, there is less risk that the situation of FIG. 5 will create the above-mentioned errors and inefficiencies.

It should be appreciated that the network device 110 may, at different times, transition among the situations in FIGS. 3 through 5. For example, if the network device 110 is lightly loaded (e.g., CPU utilization is below a predefined threshold), the network device 110 may transition back from a situation of either FIG. 4 or FIG. 5 to the situation in FIG. 3. Additionally, if the network device 110 later becomes more heavily loaded (e.g., where CPU utilization is above a predefined threshold), the network device 110 may transition from the situation of FIG. 3 to the situation of either FIG. 4 or FIG. 5, and so on.

In one or more embodiments, when transitioning from the situation of FIG. 3 to one of the situations of FIGS. 4 and 5, the network device 110 is configured to select between the optimized path monitoring situations of FIGS. 4 and 5 based on various conditions and/or settings such as configuration input, current loading, current traffic levels, current traffic types, combinations thereof, and so on. The optimized path monitoring situation of FIG. 4 advantageously provides path monitoring on the valid but inactive candidate paths 130. The optimized path monitoring situation of FIG. 5 advantageously provides minimal path monitoring loading.

### Further Details

In accordance with one or more embodiments, when a network device 110 chooses another candidate path to be the active path (e.g., see the candidate path 130(B) in FIG. 1), the network device 110 may then send test packets on the new active path at the normal rate, but dampen the sending of test packets on the remaining candidate paths that are valid but inactive. In such a situation, the new active path receives path monitoring at the normal rate.

In some situations, the previously active path may be valid but inactive. In these situations, the previously active path receives dampened path monitoring.

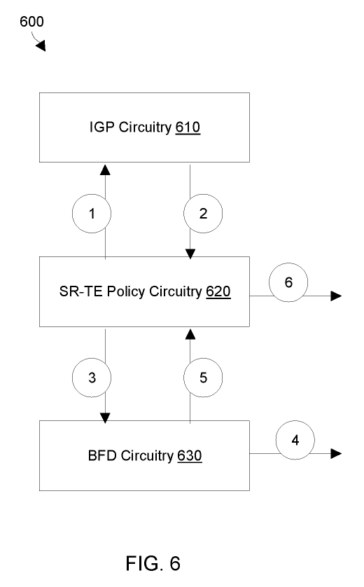

FIG. 6 shows certain components 600 of a network device 110 capable of dampening SBFD for valid but inactive candidate paths of an SR-TE policy in accordance with one or more embodiments. The components 600 include interior gateway protocol (IGP) circuitry 610, SR-TE policy circuitry (or engine) 620, and BFD circuitry 630. In some implementations, the various components 600 are formed by processing circuitry (e.g., one or more CPUs or CPU chip sets) executing respective code.

The IGP circuitry 610 of the network device 110 is constructed and arranged to forward data packets through a network. Such operation may involve exchanging routing table information with one or more other network devices 110 to find efficient pathways (e.g., see FIG. 1).

The SR-TE policy circuitry 620 of the network device 110 is constructed and arranged to select a particular valid candidate path 130 as the active candidate path for traffic steering, as well as to maintain other valid candidate paths 130 as backups. Additionally, the SR-TE policy circuitry 620 is constructed and arranged to provide commands to the BFD circuitry 630 to configure the BFD circuitry 630 to perform path monitoring.

The BFD circuitry 630 of the network device 110 is constructed and arranged to send test packets and process responses to the test packets. Depending on particular configuration commands provided by the SR-TE policy circuitry 620, the BFD circuitry 630 may send test packets at various frequencies.

During operation of the network device 110 for an SR-TE policy, the SR-TE policy circuitry 620 communicates with the IGP circuitry 610 and the BFD circuitry 630. Along these lines and as shown by the arrow (1) in FIG. 6, the SR-TE policy circuitry 620 initially provides a set of path validation requests to the IGP circuitry 610 to ascertain which candidate paths of the SR-TE policy are valid. In response, the IGP circuitry 610 evaluates reachability (e.g., via IGP, MPLS, combinations thereof, etc.). It should be appreciated that this initial exchange may occur before the SBFD circuitry 630 performs path monitoring on the candidate paths and may instead rely on the routing table knowledge managed by the IGP circuitry 610.

As shown by the arrow (2) in FIG. 6, the IGP circuitry 610 provides a set of path validation responses to the SR-TE policy circuitry 620. Based on the set of path validation responses, the SR-TE policy circuitry 620 is able to identify which candidate paths of the SR-TE policy are valid and which candidate paths of the SR-TE policy are invalid in a standard manner.

As shown by the arrow (3) in FIG. 6, the SR-TE policy circuitry 620 provides a set of requests to the BFD circuitry 630 to establish SBFD sessions for at least the valid candidate paths of the SR-TE policy. If the SR-TE policy circuitry 620 is currently operating to not impose SBFD dampening, the set of requests includes routine path monitoring criteria that is the same for all of the valid candidate paths. However, if the SR-TE policy circuitry 620 is currently operating to impose SBFD dampening on the inactive paths of the SR-TE policy, the set of requests includes both routine path monitoring criteria, which directs the BFD circuitry 630 to send test packets on the valid and active candidate path of the SR-TE policy at a routine rate, and dampening path monitoring criteria, which directs the BFD circuitry 630 operate in a dampened manner for the valid but inactive candidate paths of the SR-TE policy.

As shown by the arrow (4) in FIG. 6, in response to the set of requests, the BFD circuitry 630 establishes SBFD sessions for the respective segment lists that represent the pathways of the valid candidate paths, both active and inactive (e.g., a separate SBFD session per segment list). Additionally, the BFD circuitry 630 sends test packets and processes responses to the sent test packets in accordance with path monitoring criteria of the set of requests. Along these lines, the path monitoring criteria may specify the rates (or frequencies) at which the BFD circuitry 630 sends the test packets and the specified time limits for receiving back responses in order to consider the paths healthy.

It should be understood that the SR-TE policy circuitry 620 may continue to communicate with the BFD circuitry 630 (arrow (3)) over time (e.g., to change time intervals/rates) and/or to control whether SBFD sessions are enabled or disabled. For example, the SR-TE policy circuitry 620 may configure SBFD sessions to send test packets on inactive candidate paths at a standard rate, then at a slow rate, then at the standard rate, and so on. As another example, the SR-TE policy circuitry 620 may enable the SBFD sessions to send test packets on the inactive candidate paths, then disable the SBFD sessions from sending test packets on the inactive candidate paths, then re-enable the SBFD sessions to send test packets on the inactive candidate paths. As yet another example, the SR-TE policy circuitry 620 may configure SBFD sessions to send test packets on inactive candidate paths at the standard rate, then at the slow rate, and then disable the SBFD sessions from sending test packets on the inactive candidate paths, and so on.

In accordance with one or more embodiments, the test packet responses are stored in a queue upon receipt. Then, the SBFD circuitry 630 evaluates whether the responses were received back within the specified time limits indicated by the path monitoring criteria. Along these lines, if the responses are received back within the specified time limits, the SBFD sessions that sent the test packets remain in the “Up” state. However, if there is a response that is not received back within a specified time limit, the SBFD session that sent the test packet transitions from the “Up” state to the “Down” state.

As shown by the arrow (5) in FIG. 6, the SBFD circuitry 630 provides the SR-TE circuitry 620 with SBFD session state information. Along these lines, the SBFD circuitry 630 signals the SR-TE circuitry 620 when an SBFD session has transitioned from the “Up” state to the “Down” state. Such signaling may take the form of an event notification with minimal latency (e.g., when an SBFD session transitions from the “Up” state to the “Down” state). Alternatively, such signaling may take the form of a listing of states for all of the SBFD sessions for the SR-TE policy. Other forms of signaling are suitable for use as well.

It should be understood that the SBFD circuitry 630 may continue to communicate with the SR-TE policy circuitry 620 (arrow (5)) over time. Accordingly, the SR-TE policy circuitry 620 is able to monitor the health (or liveness) of the active candidate path.

As shown by the arrow (6) in FIG. 6, the SR-TE circuitry 620 controls which candidate path of the SR-TE policy is currently active based on the SBFD session state information from the SBFD circuitry 630 and path validation responses from the IGP circuitry 610. Although the SR-TE circuitry 620 may continue to communicate with the IGP circuitry 610 for path fault detection among other reasons, fault detection of the active candidate path may occur faster via communications between the SR-TE circuitry 620 and the SBFD circuitry 630.

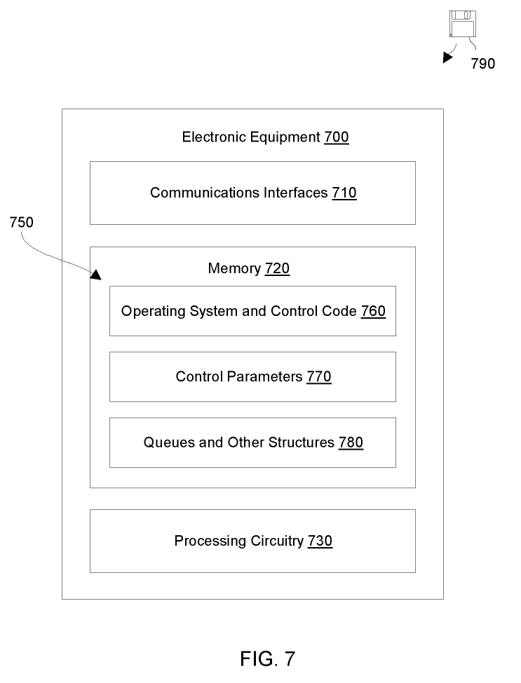

Along these lines and after a period of time, the SR-TE circuitry 620 may respond to continued signaling from the SBFD circuitry 630 and/or the IGP circuitry 610. For example, if the SBFD circuitry 630 indicates that an SBFD session has gone down, the SR-TE circuitry 620 may re-evaluate the choice of the active candidate path. That is, if that candidate path has become unhealthy, the SBFD circuitry 630 may dynamically replace that candidate path with a different valid candidate path. Further details will now be provided with reference to FIG. 7.

FIG. 7 is a block diagram of electronic equipment 700 which is suitable for forming at least some of the components 600 of FIG. 6 in accordance with certain embodiments. The electronic equipment 700 includes communications interfaces 710, memory 720, and processing circuitry 730.

The communications interfaces 710 are constructed and arranged to connect the electronic equipment 700 to a communications medium (e.g., also see the communications fabric 120 in FIG. 1) to enable communications with other devices of network environment. Along these lines, the communications interfaces 710 may include physical ports, connectors, transceivers, other hardware, combinations thereof, etc. Additionally, such communications may involve optical signals, copper-based communications, wireless signals, combinations thereof, and so on. Accordingly, the communications interfaces 710 enable the electronic equipment 700 to robustly and reliably communicate with various external apparatus (e.g., other networking devices).

The memory 720 is intended to represent both volatile storage and non-volatile storage. Along these lines, the memory 720 stores a variety of software constructs 750 including an operating system and control code 760, control parameters 770, and queues and other structures 780. The operating system and control code 760 refers to particular code such as a kernel to manage computerized resources (e.g., processor cycles, memory space, etc.), specialized code (e.g., for performing traffic steering, path monitoring, etc.), and so on. The control parameters 770 refers to various objects and data structures (e.g., policies, path monitoring criteria, tables/lists/other constructs, other control/status settings, other control plane data structures, etc.). The queues and other structures 780 refers queues, buffers, timers, workspaces, and so on to facilitate routine, packet forwarding, test packet processing, etc.

The processing circuitry 730 is constructed and arranged to operate in accordance with the various software constructs 750 stored in the memory 720. Along these lines, the processing circuitry 730 may execute one or more portions of the operating system and control code 760 to form specialized circuitry that enables the electronic equipment 700 perform traffic steering with path monitoring dampening (e.g., see the components 600 in FIG. 6). Such processing circuitry 730 may be implemented in a variety of ways including via one or more processors (or processing cores) running specialized software, application specific ICs (ASICs), field programmable gate arrays (FPGAs) and associated programs, discrete components, analog circuits, other hardware circuitry, combinations thereof, and so on.

In the context of one or more processors executing software, a computer program product 790 is capable of delivering all or portions of the software constructs 750 to the electronic equipment 700. In particular, the computer program product 790 has a non-transitory (or non-volatile) computer readable medium which stores a set of instructions that controls one or more operations of the electronic equipment 700. Examples of suitable computer readable storage media include tangible articles of manufacture and apparatus which store instructions in a non-volatile manner such as DVD, CD-ROM, flash memory, disk memory, tape memory, and the like.

It should be understood that the nothing precludes the electronic equipment 700 from obtaining one or more portions of the software constructs 750 via a technique which does not involve the computer program product 790. For example, the electronic equipment 700 may communicate with other devices in a network, sense/monitor/probe external conditions via sending and receiving test packets, etc. to derive additional information, and so on.

It should be appreciated that the structure and components of the electronic equipment 700 of FIG. 7 are provided by way of example only, and that alternative embodiments may have other structures and/or components which support the features, operations, and functionality described herein. Accordingly, the embodiments disclosed herein should not be construed to be limited by the structures and components illustrated in FIG. 7.

Also, the various individual features of the particular arrangements, configurations, and embodiments disclosed herein can be combined in any desired manner that makes technological sense. Additionally, such features are hereby combined in this manner to form all possible combinations, variants and permutations except to the extent that such combinations, variants and/or permutations have been expressly excluded or are impractical. Support for such combinations, variants and permutations is considered to exist in this document.

As described above, certain techniques are directed to dampening path monitoring in a network device for inactive candidate paths of a traffic steering policy. Such dampening may involve slowing the pace at which a path monitoring mechanism within the network device sends and receives test packets (e.g., SBFD "Hello" packets) to validate the inactive candidate paths or disabling path monitoring for the inactive candidate paths altogether. Such dampening reduces loading (resources consumed) thus enabling the network device to reliably process test packets for the candidate path of the traffic steering policy that is currently active, as well as enable the network device to effectively perform its other operations. Accordingly, such dampening avoids errors and inefficiencies, such as test packet timing requirements not being met, false indications that paths are down, and/or delayed or lost traffic due to such false indications.

While various embodiments of the present disclosure have been particularly shown and described, it will be understood by those skilled in the art that various changes in form and details may be made therein without departing from the spirit and scope of the present disclosure as defined by the appended claims.

Along these lines, in accordance with certain embodiments, path monitoring dampening may be performed at different rates on different inactive paths. For example, test packets may be sent on a first inactive path at a first dampening rate, sent on a second inactive path at a second dampening rate, and not at all on a third inactive path. Other dampening rate combinations for inactive paths are suitable for use as well.

Additionally, in accordance with certain embodiments, path monitoring dampening is applied to multi-path routing situations such as those which utilize equal-cost multi-path routing (ECMP). For example, test packets may be sent at a normal pace over multiple paths that are currently in use (e.g., over the multiple best paths). However, test packet dampening may be performed (e.g., test packets may be sent at a slower pace or not sent at all) on paths that are not currently in use.

In accordance with certain embodiments, it should be appreciated that BFD is a protocol that provides low-overhead, short-duration detection of failures of arbitrary paths between network devices. Additionally, SBFD defines a simplified mechanism for using BFD (e.g., with certain negotiation aspects eliminated). Accordingly, SBFD offers quick provisioning, and improved control and flexibility for network devices that initiate path monitoring.

Furthermore, SR-TE makes use of segment routing to allow a headend to steer traffic along any path without maintaining per flow state in every node. Along these lines, a headend steers traffic into an “SR-TE tunnel.” Currently, traffic is forwarded through an SR-TE tunnel as long as the top label is resolvable although there may be situations in which the top label is resolvable but the SR-TE tunnel is not usable and those situation may result in indefinite traffic loss.

SBFD is suitable for unidirectional forwarding path validation at the SR-TE tunnel headend. This arrangement advantageously validates the forwarding path prior to switching traffic as well as triggering fast reconvergence on path failure. Additionally, when an SBFD session goes down (transitions from the “Up” state to the “Down” state) on a forwarding path, the path is then considered invalid and will not be selected as an active path. Accordingly, the SR-TE policy converges to another candidate path with the top label resolved and with SBFD in the “Up” state. Once the SBFD session on the down path comes back up, active path re-evaluation will then pick the new best path based on predefined priority. SBFD helps achieve fast SR-TE tunnel reconvergence which in turn reduces traffic loss.

It should further be appreciated that SR-TE policies are used to steer Internet Protocol (IP) or MPLS labeled packets in traffic engineered paths. Along these lines, an SR-TE policy is represented by an endpoint and color. Each SR-TE policy includes one or more candidate paths and each of those candidate paths includes a set of (one or more) segment lists.

Additionally, each segment list is a list of segments where each segment represents a node, link or service in the topology. A segment list is the smallest unit of a policy that represents a traffic engineering forwarding construct.

Out of all the candidate paths attached with a policy, only one candidate path can be active (programmed in forwarding tables). A segment list that has a resolvable first segment is called a valid segment list and a candidate path with at least one valid segment list is called a valid candidate path. A policy can have more than one valid candidate path. However, only one valid candidate path is chosen as active and is used to steer traffic. The rest of the valid candidate paths which were not chosen (lost in the election) are kept as backups in the control plane.

At this point, it should be understood that SBFD is used with SR-TE policies to validate a path and to detect the liveness or absence of it on a path. This “path” is a segment list.

Additionally, validity of the segment list is based on the resolution of the first segment in the list. When SBFD is enabled for SR-TE policies, the validation criteria is extended so that a valid segment list has (i) the associated SBFD session in the “Up” state and (ii) a resolvable first segment. There is an SBFD session maintained for each unique segment list. If responses to BFD test packets are not received within a predefined time limit (e.g., a multiplier of the send interval), the SBFD session is torn down (disabled) and the state transitions to the “Down” state. As a result, the corresponding segment list is marked invalid and, if there are no valid segment lists remaining in the candidate path due to the event, the candidate path is marked invalid.

Unfortunately, when SBFD is enabled for a policy, SBFD sessions are run for all of the segment lists (with the first segments resolvable) of all of the candidate paths. For example, suppose that a particular SR-TE policy has three candidate paths (e.g., CP1, CP2, and CP3), and that each of those candidate paths have four segment lists (e.g., SL11, SL12, SL13, and SL14). In this example, one of those candidate paths (e.g., CP1) will be active at any point in time. Accordingly, there will be 12 SBFD sessions (three candidate paths, and four segment lists for each candidate path) at this point even though only four of those sessions are running on the candidate path that is currently active (chosen to steer traffic). All other SBFD sessions for the segment lists of the non-chosen paths (CP2 and CP3) are running unnecessarily at least until they are chosen as active.

Each SBFD sessions sends BFD test packets at regular intervals. The CPU has to send and receive replies to the test packets and such activity is work. Moreover, the work increases as the number of SR-TE policies, candidate paths per policy, and segment lists per candidate path increases. On a networking device that has protocols running (some IGP for example), the CPU has to process the test packets and other control packets of such protocols. This causes the CPU to not keep up with things and issues in the network. Accordingly, the possibility exists that IGP sessions or SBFD sessions could go down because test packets in some queue did not get a change to be processed.

Advantageously, certain embodiments reduce the load on the resources that need to process the SBFD test packets for the inactive segment lists (valid segment lists that belong to inactive candidate paths). Along these lines, such load reduction involves slowing down the pace at which test packets are sent and replies to the test packets are received or disabling SBFD for the inactive segment lists. The option of slowing down the pace enables continued path monitoring (liveness detection) even though less aggressively.

Some embodiments are directed to a method of dampening path monitoring in a network device. The method includes providing a traffic steering policy that specifies a first valid candidate path and a second valid candidate path. The method further includes, in response to the first valid candidate path being active, configuring a path monitoring mechanism to apply routine path monitoring criteria to the first valid candidate path to perform path monitoring on the first valid candidate path at a routine level. The method further includes, in response to the second valid candidate path being inactive, configuring the path monitoring mechanism to apply dampening path monitoring criteria to the second valid candidate path to dampen path monitoring on the second valid candidate path below the routine level.

Other embodiments are directed to a network device which includes memory, and processing circuitry coupled with the memory. The memory stores instructions which, when carried out by the processing circuitry, cause the processing circuitry to perform a method which includes providing a traffic steering policy that specifies a first valid candidate path and a second valid candidate path. The method further includes, in response to the first valid candidate path being active, configuring a path monitoring mechanism to apply routine path monitoring criteria to the first valid candidate path to perform path monitoring on the first valid candidate path at a routine level. The method further includes, in response to the second valid candidate path being inactive, configuring the path monitoring mechanism to apply dampening path monitoring criteria to the second valid candidate path to dampen path monitoring on the second valid candidate path below the routine level.

Yet other embodiments are directed to a computer program product having a non-transitory computer readable medium which stores a set of instructions to dampen path monitoring in a network device. The set of instructions, when carried out by computerized circuitry, causes the computerized circuitry to perform a method which includes providing a traffic steering policy that specifies a first valid candidate path and a second valid candidate path. The method further includes, in response to the first valid candidate path being active, configuring a path monitoring mechanism to apply routine path monitoring criteria to the first valid candidate path to perform path monitoring on the first valid candidate path at a routine level. The method further includes, in response to the second valid candidate path being inactive, configuring the path monitoring mechanism to apply dampening path monitoring criteria to the second valid candidate path to dampen path monitoring on the second valid candidate path below the routine level.

In some embodiments, providing the traffic steering policy includes performing a path selection operation which identifies the first valid candidate path as being active and the second valid candidate path as being inactive.

In some embodiments, the traffic steering policy represents the first valid candidate path using a set of first segment lists which defines a set of first pathways between the network device and an endpoint device. Additionally, configuring the path monitoring mechanism to apply the routine path monitoring criteria to the first valid candidate path includes directing a set of first path monitoring sessions to periodically send a set of test packets on the set of first pathways at a routine rate.

In some embodiments, the traffic steering policy represents the second valid candidate path using a set of second segment lists which defines a set of second pathways between the network device and the endpoint device. Additionally, configuring the path monitoring mechanism to apply the dampening path monitoring criteria to the second valid candidate path includes directing a set of second path monitoring sessions to periodically send a set of test packets on the set of second pathways at a dampening rate that is slower than the routine rate.

In some embodiments, the method further includes, after directing the set of second path monitoring sessions to periodically send the set of test packets on the set of second pathways at the dampening rate, performing a second path selection operation which identifies the second valid candidate path as being active in place of the first valid candidate path. The method further includes, in response to the second valid candidate path being active, directing the set of second path monitoring sessions to periodically send the set of test packets on the set of second pathways at the routine rate.

In some embodiments, performing the second path selection operation further identifies the first valid candidate path as being inactive. The method further includes, in response to the first valid candidate path being inactive, directing the set of first path monitoring sessions to periodically send the set of test packets on the set of first pathways at the dampening rate that is slower than the routine rate.

In some embodiments, the method further includes, after directing the set of second path monitoring sessions to periodically send the set of test packets on the set of second pathways at the routine rate, performing a third path selection operation which identifies the first valid candidate path as again being active and the second valid candidate path as again being inactive. The method further includes, in response to the first valid candidate path again being active, directing the set of first path monitoring sessions to periodically send the set of test packets on the set of first pathways at the routine rate. The method further includes, in response to the second valid candidate path again being inactive, directing the set of second path monitoring sessions to periodically send the set of test packets on the set of second pathways at the dampening rate that is slower than the routine rate.

In some embodiments, the traffic steering policy represents the second valid candidate path using a set of second segment lists which defines a set of second pathways between the network device and the endpoint device. Additionally, configuring the path monitoring mechanism to apply the dampening path monitoring criteria includes disabling a set of second path monitoring sessions from sending test packets on the set of second pathways.

In some embodiments, the method further includes, after disabling the set of second path monitoring sessions from sending test packets on the set of second pathways, performing a second path selection operation which identifies the second valid candidate path as being active in place of the first valid candidate path. The method further includes, in response to the second valid candidate path being active, enabling the set of second path monitoring sessions to periodically send the set of test packets on the set of second pathways at the routine rate.

In some embodiments, performing the second path selection operation further identifies the first valid candidate path as being inactive. The method further includes disabling the set of first path monitoring sessions from sending test packets on the set of first pathways.

In some embodiments, the method further includes, after enabling the set of second path monitoring sessions to periodically send the set of test packets on the set of second pathways at the routine rate, performing a third path selection operation which identifies the first valid candidate path as again being active and the second valid candidate path as again being inactive. The method further includes, in response to the first valid candidate path again being active, enabling the set of first path monitoring sessions to periodically send the set of test packets on the set of first pathways at the routine rate. The method further includes, in response to the second valid candidate path again being inactive, disabling the set of second path monitoring sessions from sending test packets on the set of second pathways.

In some embodiments, the traffic steering policy is a Segment Routing Traffic Engineering (SR-TE) policy that defines, as the first and second valid candidate paths, traffic engineered paths between the network device and an endpoint device. Additionally, providing the traffic steering policy further includes, prior to performing the path selection operation, performing validation operations that indicate that a set of first segments lists, which represents the first valid candidate path, has at least one valid first segment list and that a set of second segments lists, which represents the second valid candidate path, has at least one valid second segment list.

In some embodiments, the path monitoring mechanism is constructed and arranged to issue Bidirectional Forwarding Detection (BFD) "Hello" packets in accordance with the Seamless Bidirectional Forwarding Detection (SBFD) protocol. The method further includes, prior to configuring the path monitoring mechanism to apply the routine path monitoring criteria and the dampening path monitoring criteria, directing the path monitoring mechanism to establish SBFD sessions for the traffic engineered paths defined by the SR-TE policy.

In some embodiments, the method further includes, after the SBFD sessions are established and the path monitoring mechanism is configured to apply the routine path monitoring criteria and the dampening path monitoring criteria, monitoring states of the SBFD sessions and performing additional path selection operations in response to changes in the states of the SBFD sessions.

Other embodiments are directed to electronic systems, assemblies, processing circuits, other apparatus and articles of manufacture, and so on. Some embodiments are directed to various methods, componentry and circuitry which are involved in dampening path monitoring in a network device.

As indicated earlier, modifications may be made in light of the foregoing description of the illustrated embodiments and are to be included within the spirit and scope of the disclosure. Moreover, while particular embodiments are described, a latitude of modification, various changes and substitutions are intended in the foregoing disclosures and it should be appreciated that in some instances some features of the embodiments may be employed without a corresponding use of other features, and feature described with respect to one embodiment may be combined with features of one or more other embodiments without departing from the scope and spirit of the disclosure.

What is claimed is:

1. A method of dampening path monitoring in a network device, the method comprising:
providing a traffic steering policy that specifies a first valid candidate path and a second valid candidate path;
in response to the first valid candidate path being active, configuring a path monitoring mechanism to apply routine path monitoring criteria to the first valid candidate path to perform path monitoring on the first valid candidate path at a routine level; and
in response to the second valid candidate path being inactive, configuring the path monitoring mechanism to apply dampening path monitoring criteria to the second valid candidate path to dampen path monitoring on the second valid candidate path below the routine level.

2. The method as in claim 1, wherein providing the traffic steering policy includes:
performing a path selection operation which identifies the first valid candidate path as being active and the second valid candidate path as being inactive.

3. The method as in claim 2, wherein the traffic steering policy represents the first valid candidate path using a set of first segment lists which defines a set of first pathways between the network device and an endpoint device; and
wherein configuring the path monitoring mechanism to apply the routine path monitoring criteria to the first valid candidate path includes:
directing a set of first path monitoring sessions to periodically send a set of test packets on the set of first pathways at a routine rate.

4. The method as in claim 3, wherein the traffic steering policy represents the second valid candidate path using a set of second segment lists which defines a set of second pathways between the network device and the endpoint device; and
wherein configuring the path monitoring mechanism to apply the dampening path monitoring criteria to the second valid candidate path includes:
directing a set of second path monitoring sessions to periodically send a set of test packets on the set of second pathways at a dampening rate that is slower than the routine rate.

5. The method as in claim 4, further comprising:
after directing the set of second path monitoring sessions to periodically send the set of test packets on the set of second pathways at the dampening rate, performing a second path selection operation which identifies the second valid candidate path as being active in place of the first valid candidate path; and
in response to the second valid candidate path being active, directing the set of second path monitoring sessions to periodically send the set of test packets on the set of second pathways at the routine rate.

6. The method as in claim 5 wherein performing the second path selection operation further identifies the first valid candidate path as being inactive; and
wherein the method further comprises:
in response to the first valid candidate path being inactive, directing the set of first path monitoring sessions to periodically send the set of test packets on the set of first pathways at the dampening rate that is slower than the routine rate.

7. The method as in claim 5, further comprising:
after directing the set of second path monitoring sessions to periodically send the set of test packets on the set of second pathways at the routine rate, performing a third path selection operation which identifies the first valid candidate path as again being active and the second valid candidate path as again being inactive;
in response to the first valid candidate path again being active, directing the set of first path monitoring sessions to periodically send the set of test packets on the set of first pathways at the routine rate; and
in response to the second valid candidate path again being inactive, directing the set of second path monitoring sessions to periodically send the set of test packets on the set of second pathways at the dampening rate that is slower than the routine rate.

8. The method as in claim 3, wherein the traffic steering policy represents the second valid candidate path using a set of second segment lists which defines a set of second pathways between the network device and the endpoint device; and
wherein configuring the path monitoring mechanism to apply the dampening path monitoring criteria includes:
disabling a set of second path monitoring sessions from sending test packets on the set of second pathways.

9. The method as in claim 8, further comprising:
after disabling the set of second path monitoring sessions from sending test packets on the set of second pathways, performing a second path selection operation which identifies the second valid candidate path as being active in place of the first valid candidate path; and
in response to the second valid candidate path being active, enabling the set of second path monitoring sessions to periodically send the set of test packets on the set of second pathways at the routine rate.

10. The method as in claim 9 wherein performing the second path selection operation further identifies the first valid candidate path as being inactive; and
wherein the method further comprises:
disabling the set of first path monitoring sessions from sending test packets on the set of first pathways.

11. The method as in claim 9, further comprising:
after enabling the set of second path monitoring sessions to periodically send the set of test packets on the set of second pathways at the routine rate, performing a third path selection operation which identifies the first valid candidate path as again being active and the second valid candidate path as again being inactive;
in response to the first valid candidate path again being active, enabling the set of first path monitoring sessions to periodically send the set of test packets on the set of first pathways at the routine rate; and
in response to the second valid candidate path again being inactive, disabling the set of second path monitoring sessions from sending test packets on the set of second pathways.

12. The method as in claim 2, wherein the traffic steering policy is a Segment Routing Traffic Engineering (SR-TE) policy that defines, as the first and second valid candidate paths, traffic engineered paths between the network device and an endpoint device; and
wherein providing the traffic steering policy further includes:
prior to performing the path selection operation, performing validation operations that indicate that a set of first segments lists, which represents the first valid candidate path, has at least one valid first segment list and that a set of second segments lists, which represents the second valid candidate path, has at least one valid second segment list.

13. The method as in claim 12, wherein the path monitoring mechanism is constructed and arranged to issue Bidirectional Forwarding Detection (BFD) "Hello" packets in accordance with the Seamless Bidirectional Forwarding Detection (SBFD) protocol; and
wherein the method further comprises:
prior to configuring the path monitoring mechanism to apply the routine path monitoring criteria and the dampening path monitoring criteria, directing the path monitoring mechanism to establish SBFD sessions for the traffic engineered paths defined by the SR-TE policy.

14. The method as in claim 13, further comprising:
after the SBFD sessions are established and the path monitoring mechanism is configured to apply the routine path monitoring criteria and the dampening path monitoring criteria, monitoring states of the SBFD sessions and performing additional path selection operations in response to changes in the states of the SBFD sessions.

15. A network device, comprising:
memory; and
processing circuitry coupled with the memory, the memory storing instructions which, when carried out by the processing circuitry, cause the processing circuitry to:
provide a traffic steering policy that specifies a first valid candidate path and a second valid candidate path;
in response to the first valid candidate path being active, configure a path monitoring mechanism to apply routine path monitoring criteria to the first valid candidate path to perform path monitoring on the first valid candidate path at a routine level; and
in response to the second valid candidate path being inactive, configure the path monitoring mechanism to apply dampening path monitoring criteria to the second valid candidate path to dampen path monitoring on the second valid candidate path below the routine level.

16. The network device of claim 15, wherein the processing circuitry, when providing the traffic steering policy, is constructed and arranged to:
select the first valid candidate path as being active and the second valid candidate path as being inactive.

17. The network device of claim 16, wherein the processing circuitry is further constructed and arranged to:
prior to configuring the path monitoring mechanism to apply the routine path monitoring criteria and the dampening path monitoring criteria, direct the path monitoring mechanism to establish path monitoring sessions for the routine valid candidate path and the second valid candidate path specified by the traffic steering policy.

18. The network device of claim 17, wherein the processing circuitry is further constructed and arranged to:
after the path monitoring sessions are established and the path monitoring mechanism is configured to apply the routine path monitoring criteria and the dampening path monitoring criteria, monitor states of the path monitoring sessions and perform additional path selection operations in response to changes in the states of the path monitoring sessions.

19. A computer program product having a non-transitory computer readable medium which stores a set of instructions to dampen path monitoring in a network device; the set of instructions, when carried out by computerized circuitry, causing the computerized circuitry to perform a method of:
providing a traffic steering policy that specifies a first valid candidate path and a second valid candidate path;
in response to the first valid candidate path being active, configuring a path monitoring mechanism to apply routine path monitoring criteria to the first valid candidate path to perform path monitoring on the first valid candidate path at a routine level; and
in response to the second valid candidate path being inactive, configuring the path monitoring mechanism to apply dampening path monitoring criteria to the second valid candidate path to dampen path monitoring on the second valid candidate path below the routine level.
